(19) United States
(12) Patent Application Publication
(10) Pub. No.: US 2005/0112313 A1
(43) Pub. Date: May 26, 2005

(54) Time delayed message labels

(76) Inventors: Rick Steven Constantine, Norwalk, CT (US); Allan Sacks, Stanford, CT (US); Ernest Pedicano, Valhalla, NY (US)

Correspondence Address: BAKER & BOTTS, 30 ROCKEFELLER PLAZA, NEW YORK, NY, 10112, US

(21) Appl. No.: 10/967,830

(22) Filed: Oct. 18, 2004

Related U.S. Application Data
(60) Provisional application No. 60/513,414, filed on Oct. 22, 2003.

(51) Int. Cl. B32B 9/00

(52) U.S. Cl. 428/40.1; 428/195.1

(57) ABSTRACT

A new and improved label for delivering at least one time delayed message that includes at least two migrating agents is disclosed. The time delayed message is printed on a label that is printable through an automatic label printer. A second layer that includes a substantially non-curing polymer coating may then be placed over the migrating agents to begin migration and display the message.

### CLAIM OF PRIORITY

This application claims priority under 35 U.S.C. §119 from U.S. provisional application 60/513,414 filed Oct. 22, 2003, the disclosure of which is incorported herein by reference.

### FIELD OF THE INVENTION

The present invention relates to a label for delivering a time delayed message. More particularly, the present invention relates to a label for delivering a time delayed message using multiple inks and improved time control.

### BACKGROUND OF THE INVENTION

Time-delayed message label systems typically contain an ink, i.e. a message or image, that gradually migrates through a film overlay. When the system is first activated, the message is not immediately visible. As the ink diffuses through the upper layers, the message slowly begins to appear until it becomes sufficiently strong and clear as to be readily visible. A common characteristic of such systems is that a single ink is used that gradually develops into the message. One practical limitation of previous message display systems is that the displayed image develops slowly and the message or image may not be immediately recognizable. Consequently, during and even after diffusion of a single ink system the message may be confusing or ill-defined. In certain applications in which a long delay between activation of the system and development of the message is desired, this effect will be even more pronounced. Therefore, a message display system that contains multiple inks that develop over a controlled amount of time is desirable.

### SUMMARY OF THE INVENTION

The present invention relates to a label for delivering a time delayed message. More particularly, the present invention relates to a label for delivering a time delayed message using multiple inks and improved time control.

It is one object of the present invention to provide a new and improved label for delivering at least one time delayed message comprising at least two migrating agents. It is a further object of the present invention to provide a time delayed message that migrates through a substantially non-curing polymer coating to be viewed through a second layer. It is still a further object of the present invention, to provide a label that. is feedable through an automatic label printer. It is yet another object of the present invention to provide a label for delivering a time delayed message wherein the time delayed message includes at least two migrating agents and may be printed with an automatic label printer

It is another object of the present invention to provide a new and improved label for delivering at least one time delayed message comprising at least two migrating agents that includes: a base layer including at least two migrating agents arranged to form at least one message on a first surface of a substantially impermeable base layer; a second layer including a substantially non-curing polymer coating on a first surface of the second layer; and a removable release sheet arranged between at least one portion of the base layer and the first surface of the second layer wherein the release sheet prevents contact of the at least two migrating agents and the second layer wherein removal of the release sheet allows migration of the at least two migrating agents through the substantially non-curing polymer coating to display a message.

Other and further objects, features and advantages of the present invention will be readily apparent to those skilled in the art upon a reading of the description of preferred embodiments which follows.

### BRIEF DESCRIPTION OF THE DRAWINGS

For a better understanding of the present invention, together with other and further objects thereof, reference is made to the following description, taken in conjunction with the accompanying drawings, and its scope will be pointed out in the appending claims.

FIG. 1 is a side view of the time delayed message labels of the present invention;

FIG. 2 is a perspective view of the time delayed message labels of the present invention;

FIG. 3 is a perspective view of the time delayed message labels shown in FIG. 2; and

FIG. 4 is a cross-section view of the time delayed message labels shown in FIG. 3.

FIG. 5 is an exemplary embodiment of the time delayed message labels of the present invention.

FIG. 6 is a second exemplary embodiment of the time delayed message labels of the present invention.

### DESCRIPTION OF THE PREFERRED EMBODIMENTS

In one exemplary embodiment of the present invention a label for delivering at least one time delayed message comprising at least two migrating agents is provided. The label may be made of a substantially impermeable material to prevent the migrating agents from diffusing through the label. For example, the label may be made from a polyester. In a further embodiment the label may be feedable through an automatic label printer. The automatic label printer may be used to print the time delayed message that includes at least two migrating agents on the label. In a further exemplary embodiment the label may include an adhesive layer so that the printed label may be adhered to a surface.

In a further embodiment of the present invention, the time delayed message printed on the label may migrate to be viewed through a second layer. For example, the second layer may be a substantially impermeable material, e.g. a polyester, that has a substantially non-curing polymer coating on one side, e.g. a plasticizer-vinyl-titanium dioxide mixture. To begin migration this second layer may be placed over the label in contact with the message containing the at least two migrating agents. Once in contact the migrating agents, i.e. the message, begins to diffuse through the coating and may be displayed through the second layer.

In a further exemplary embodiment of the present invention, migration of the migrating agents may be controlled independently. In one embodiment, the migrating agents may migrate through the substantially non-curing polymer coating at substantially the same time. In another exemplary embodiment, the migrating agents may migrate through the substantially non-curing polymer coating at different times. In one exemplary embodiment migration may occur over about 12 hours.

In a further embodiment of the present invention, the migrating agents may be colored inks. In still a further embodiment, the migrating agents may be different colored inks. In one example, the label may contain a message that includes a stop sign comprising at least two migrating inks of different colors. A label containing a stop sign comprising at least two migrating inks may be useful in a variety of applications where a universally understood message or warning is desired. For example, a message that includes a stop sign may be used in security badges as a readily recognizable alert that authorization is no longer approved.

In still a further embodiment of the present invention, the label may include a non-migrating component. In one example, this non-migrating component may itself be a message. In a further embodiment, the non-migrating component may substantially conceal the message contained in the migrating agents such that after the message migrates through the non-curing polmer coating it may be visible through the second layer.

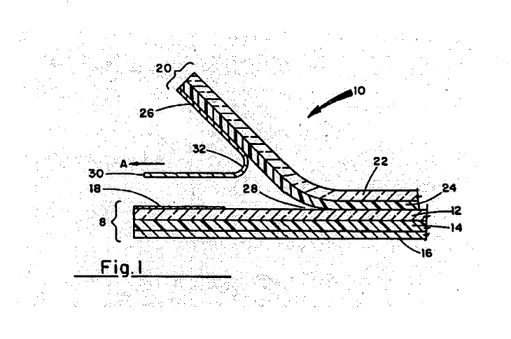

Another exemplary embodiment of a label for delivering at least one time delayed message is shown in the FIG. 1. The time delayed message labels 10 of one exemplary embodiment include a base 8 and an indicator layer 20. The base 8 includes a substantially impermeable base layer 12 coated on one surface. In a further exemplary embodiment, the base 8 includes an adhesive layer 14 and a liner 16 arranged on the adhesive layer 14 wherein the liner is capable of releasably adhering to the adhesive layer 14. Adhesive layer 14 and liner 16 are optional, but provide for convenient manufacture and use of adhesive labels of the present invention in any given application. On a portion of the other surface of substantially impermeable base layer 12 may be at least two migrating agents arranged in at least one message 18. The indicator layer 20 comprises a clear substantially impermeable top second layer 22, a non-curing polymer coating 24, and a removable release sheet 26.

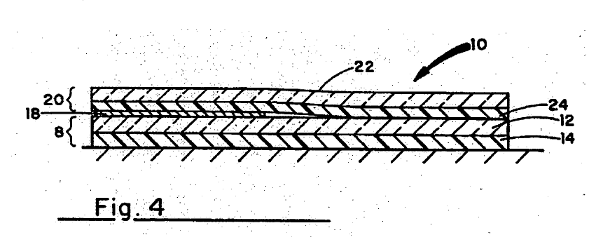

In a further embodiment, the removable release sheet 26 is partially removed or peeled back, and the exposed area 28 of the non-curing polymer coating 24 contacts and adheres to a portion of the surface of the base layer 12, which is adjacent to the message 18. In a further embodiment of the present invention, the removable release sheet is partially peeled-back to form a gripping tab 30. The top of the release sheet 26 is removably adhered to non-curing polymer coating 24 at all areas except where release sheet 26 has been partially peeled back to form gripping tab 30 and exposes coating 24 to contact base layer 12 at contact area 28. The release sheet 26 is peeled back and folded at fold line 32, such that message 18 does not contact coating 24 in the pre-activation position as shown in FIG. 1. To activate the time delayed message labels, gripping tab 30 is pulled in the direction of arrow “A” to peel the remainder of the removable release sheet 26 from indicator layer 20. Because indicator layer 20 is secured to base layer 12 at contact area 28, indicator layer 20 becomes disposed over message 18 to activate the indicator as shown in FIG. 4.

In a further embodiment of the present invention, message 18 further includes a non-migrating component, which may be a preprinted message. In still a further embodiment, the non-migrating component conceals the message corresponding to the migrating agents.

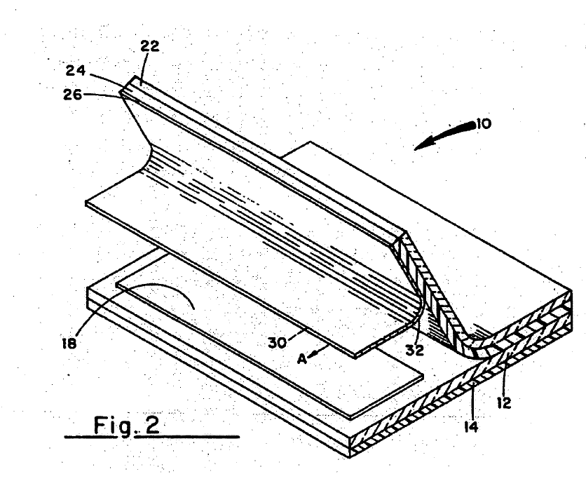

FIG. 2 is a perspective view of an exemplary time delayed message label mounted to a receiving surface. As shown in FIG. 2, release sheet 16 has been removed and background coating 14 is adhered to a receiving surface. Label 10 is shown in the pre-activation position.

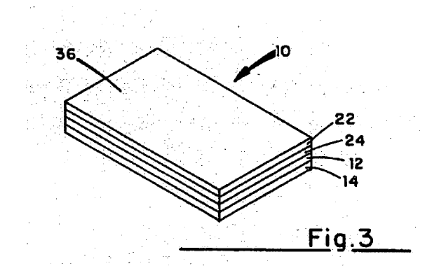

FIG. 3 is a perspective view of the indicator after activation and transfer of message 18. The label is shown with the liner 16 removed, the adhesive 14 securing the label to a receiving surface. In the activated position, the non-curing polymer coating 24 contacts and adheres to base layer 12, with the coating 24 contacting the message 18.

FIG. 4 is a side cross-section view of the time delayed message labels of FIG. 3 showing indicator layer 20 overlying message 18, with non-curing polymer coating 24 in contact with message 18. The migrating component of message 18 may migrate through the non-curing polymer coating 24 to display the message. In one embodiment, coating 24 is an opaque plasticizer-vinyl-titanium dioxide that provides a background for the message display and may obscure any non-migrating component of the message area 18.

Second layer 22 and substantially impermeable base layer 12 are preferably made of substantially impermeable polyester. In one example, clear “Mylar” film, available from E.I. duPont de Nemours & Co., may be used. In the context of the present invention, the term “impermeable” as used to describe indicator layer 22 and substrate layer 12 shall be understood to mean that the layers have a molecular structure that effectively prevents passage of the migrating agent into or through these layers during operative time periods. Therefore, impermeable base layer 12 effectively prevents the migrating agent contained in message 18 from migrating downwardly during operative time periods. In a preferred embodiment, the second layer 22 similarly prevents transfer of the migrating agent through top layer 22. In one embodiment, adhesive layer 14 and non-curing polymer coating 24 may be made of the same mixture. One preferred non-curing polymer coating mixture contains about sixty four percent (64%) by weight polyester plasticizer, for example “ADMEX” from Huls America, Inc., Piscataway, N.J., about twenty percent (20%) by weight titanium dioxide (TiO₂), and about sixteen percent (16%) by weight polyvinyl chloride resin.

To facilitate a better understanding of the present invention, the following example of some of the preferred embodiments are given. In no way should such example be read to limit the scope of the invention.

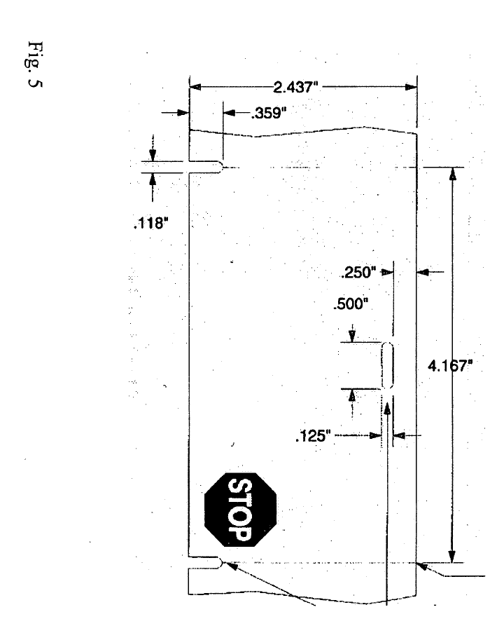

In one example, the time delayed message labels of the present invention may be used as a security badge, as shown in FIG. 5. The security badge may be about the size of a typical credit card and contain a message in the form of a stop sign. The stop sign may contain migrating red ink with a border of migrating black ink. When the badge is issued the time delayed message label is activated and after a predetermined period of time the stop sign of the label would become visible indicating that access was no longer permitted. The multicolor label would increase the resolution of the badge and make the image more readily visible as shown in FIG. 6.

Therefore, the present invention is well-adapted to carry out the objects and attain the ends and advantages mentioned as well as those that are inherent therein. While the invention has been depicted, described, and is defined by reference to exemplary embodiments of the invention, such a reference does not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalence in all respects.

1. A label for delivering at least one time delayed message comprising at least two migrating agents.

2. The label of claim 1 wherein said label is substantially impermeable.

3. The label of claim 1 wherein said label comprises a clear polyester.

4. The label of claim 1 wherein said label is feedable through an automatic label printer.

5. The label of claim 1 wherein said at least one time delayed message comprising at least two migrating agents is printed with an automatic label printer.

6. The label of claim 1 wherein said label further comprises:
an adhesive layer arranged on a second surface of said label; and
a liner arranged on said adhesive layer, wherein said liner is capable of releasably adhering to the adhesive layer.

7. The label of claim 6 wherein said adhesive layer comprises a plasticizer-vinyl-titanium dioxide mixture.

8. The label of claim 1 wherein said time delayed message migrates through a substantially non-curing polymer coating to be viewed through a second layer.

9. The label of claim 1 wherein said non-curing polmer coating comprises a plasticizer-vinyl-titanium dioxide mixture.

10. The label of claim 2 wherein said second layer is substantially impermeable.

11. The label of claim 2 wherein said second layer is a clear polyester.

12. The label of claim 1 wherein the migration of each of said at least two migrating agents is controllable independently.

13. The label of claim 1 wherein said at least two migrating agents migrate through said substantially non-curing polymer coating at substantially the same time.

14. The label of claim 1 wherein said at least two migrating agents migrate through the substantially non-curing polymer coating at different times.

15. The label of claim 1 wherein the migration of said at least two migrating agents occurs over about 12 hours.

16. The label of claim 1 wherein said at least two migrating agents are colored inks.

17. The label of claim 1 wherein the at least two migrating agents comprise different colored inks.

18. The label of claim 1 wherein the message comprises a stop sign comprising at least two migrating inks of different colors.

19. The label of claim 1 wherein said label further comprises a non-migrating component.

20. The label of claim 19 wherein said non-migrating component substantially conceals said at least two migrating agents arranged in at least one message.

21. The label of claim 20 wherein said at least one message is visible after migration through said non-curing polmer coating.

22. A time delayed message label comprising:
a base layer comprising at least two migrating agents arranged to form at least one message on a first surface of a substantially impermeable base layer;
a second layer comprising a substantially non-curing polymer coating on a first surface of the second layer; and
a removable release sheet arranged between at least one portion of the base layer and the first surface of the second layer wherein the release sheet prevents contact of the at least two migrating agents and the second layer wherein removal of the release sheet allows migration of the at least two migrating agents through the substantially non-curing polymer coating to display a message.

23. The time delayed message label of claim 1 wherein said substantially impermeable base further comprises:
an adhesive layer arranged on a second surface of said substantially impermeable base layer; and
a liner arranged on said adhesive layer, wherein said liner is capable of releasably adhering to the adhesive layer.

24. The time delayed message label of claim 1 wherein said non-curing polmer coating comprises a plasticizer-vinyl-titanium dioxide mixture.

25. The time delayed message label of claim 2 wherein said adhesive layer comprises a plasticizer-vinyl-titanium dioxide mixture.

26. The time delayed message label of claim 1 wherein said base layer is substantially impermeable.

27. The time delayed message label of claim 1 wherein said base layer comprises a clear polyester.

28. The time delayed message label of claim 1 wherein said second layer is substantially impermeable.

29. The time delayed message label of claim 1 wherein said second layer is a clear polyester.

30. The time delayed message label of claim 1 wherein said base layer further comprises a preprinted non-migrating component.

31. The time delayed message label of claim 9 wherein said preprinted non-migrating component substantially conceals the at least two inks containing migrating agents arranged in at least one message.

32. The time delayed message label of claim 1 wherein said removable release sheet further comprises a gripping tab.

33. The time delayed message label of claim 1 wherein the migration time of each of the at least two migrating agents is controllable independently.

34. The time delayed message label of claim 1 wherein said at least two migrating agents migrate through the substantially non-curing polymer coating at substantially the same time.

35. The time delayed message label of claim 1 wherein said at least two migrating agents migrate through the substantially non-curing polymer coating at different times.

36. The time delayed message label of claim 1 wherein said at least two migrating agents are colored inks.

37. The time delayed message label of claim 1 wherein said label is feedable through an automatic label printer.

38. The time delayed message label of claim 1 wherein said second layer may be printed with a label printer before or after removal of the removable release sheet.

39. The time delayed message label of claim 1 wherein the at least two migrating agents comprise different colored inks.

40. The time delayed message label of claim 1 wherein said time expiring label is a security badge.

41. The time delayed message label of claim 19 wherein the message comprises a stop sign comprising at least two migrating inks of different colors.
